(19) United States
(12) Patent Application Publication
(10) Pub. No.: US 2006/0260076 A1
(43) Pub. Date: Nov. 23, 2006

(54) Car washing arm

(76) Inventor: Dan Hanna, Portland, OR (US)

Correspondence Address: Carl D. Crowell, P.O. Box 923, Salem, OR, 97308-0923, US

(21) Appl. No.: 11/130,984

(22) Filed: May 17, 2005

(51) Int. Cl. B60S 3/06

(52) U.S. Cl. 15/53.2

(57) ABSTRACT

An apparatus for treating the exterior vertical surfaces of a vehicle has a vertical support member which has a first end attached to the floor and an opposing second end. There is a horizontal support arm that has a first arm end pivotally attached to the opposing second end of the vertical support member and a second arm end. The horizontal support arm has an approximate ninety degree bend proximate the first arm end. The horizontal support arm is essentially parallel to the ground and approximately eight feet above the ground. A spinning brush is rotatably attached to the second arm end and perpendicular to the horizontal support arm. The spinning brush has at least one vertical washing fabric attached vertically to the spinning brush. The spinning brush rotates horizontally.

### FIELD OF THE INVENTION

This invention relates to the field of cleaning machines and more particularly, to an improved apparatus for washing vertical surfaces on vehicles.

### BACKGROUND OF THE INVENTION

Vehicle washing services or car washes have been known for decades. Often such car washes utilize washing machines that are designed to wash particular portions of the vehicle. For example, one known type of washing machine has a vertical axis of brushes that is used to wash vertical surfaces of the vehicle as the vehicle moves past the washing machine. The vehicle is either driven or conveyed past the washing machine. With some car washes, one or more rotating vertical brushes are stationary and simply wash one or more side surfaces as the vehicle moves past the brushes. With other car washes, a rotating brush is located at one side of the vehicle and is moved along a path parallel to the path of vehicle travel.

With still other car washes, a brush is mounted at the far end of a straight pivot arm having its opposite end pivotally connected to a frame above the vehicle, In this case, the brush is used to wash one side and one or both ends of the vehicle. In order to best wash the front end of a vehicle, the proximal end of the pivot arm should extend far enough to reach the center portion of the vehicle front. The force of the car is used to push the pivot arm away and around the vehicle, thereby allowing the spinning brushes to move across the front of the car as the car moves forward. The pivot arm is under tension at or near the attachment point to the overhead frame biasing the pivot arm and vertical brush toward the car. After moving across the front of the vehicle, the tension keeps the brushes against the side of the car until the vehicle passes by completely. Finally, the tension returns the pivot arm to its initial position to begin washing the next car.

A critical design decision with such machines is the determination of the amount of tension to apply to the rotating brush pivot arm so that adequate pressure is applied to the rotating brushes pressing against the vehicle in order to provide a quality washing. As the pivot arm is rotated and the rotating brushes move across the front and down the sides of the vehicle, there is a significant decrease in pressure against the vehicle. In order to get a quality cleaning down the side of the vehicle, the pressure at the beginning of the process must be great enough to compensate for this pressure decrease. If the initial pressure is increased too much in an effort to improve the washing down the sides of the car, often one of the spinning brushes will hang up on a grill guard or license plate ripping the item off the car.

One way to improve the travel across the front of the vehicle is to spin the brushes in the direction of the movement of the vehicle, i.e. the brushes on the left of the vehicle as it moves through are spinning counter-clockwise while the brushes on the right side of the vehicle rotate in a clockwise direction. This method of rotation assists the rotational force of the pivot arm in moving the brushes out of the way as the car proceeds through the wash. Essentially, the rotation allows the brushes to walk across the front of the vehicle. Unfortunately, this rotation is not as affective down the sides of the vehicle. Even though this rotation minimizes the loss of license plates and other grill attachments, it tends to push the brushes away from the sides of the vehicle giving minimal scrubbing pressure as the brushes are turning.

If the brushes are rotated against the movement of the vehicle, there is more cleaning power down the sides of the vehicle. Unfortunately, by reversing the direction of the brushes on these high pressure arms the brushes are rotating into the car rather than with the movement of the car and the rotating brush force against the front of the vehicle pulls the arm into the vehicle. When this happens, enough force is added to the normal tensioning force on the arm that it does not allow the brushes to be pushed or moved out of the way during the washing of the vehicle and the vehicle impacts with the brushes. The traditional balance struck with the prior art is to rotate the brushes with the movement of the car with a force that will minimize the stripping off of license plates and grill guards, while adding a quick manual brushing or wiping on the car sides prior to the automatic washing in an effort to improve the quality of the low pressure side washing.

There is a need for an improved car wash that applies a more constant pressure across the front and down the sides of a vehicle without compromising the economy of the process, the quality of the wash, or the exterior fixtures on the vehicle.

### SUMMARY OF THE INVENTION

The present invention is an improved car washing arm for treating the exterior vertical surfaces of a vehicle. The main objective of the present invention is to provide an improved car washing arm that applies a more constant and consistent pressure to the car during washing.

Another objective of the present invention is to provide an improved car washing arm that sufficiently cleans the sides of the car while providing a less destructive process than the prior art.

It is yet another objective of the present invention to provide a car washing arm that requires a smaller space thereby conserving water, energy and real estate.

Still further objects and advantages will become apparent from a study of the following description and the accompanying drawings.

### BRIEF DESCRIPTION OF THE DRAWINGS

FIG. 1 is a perspective view of a car wash depicting the placement of the improved pivot arm of the present invention.

FIG. 2a-2d is a series of sequential plan views comparing the movement of the straight pivot arm of the prior art and the bent pivot arm of the present invention around a vehicle as it proceeds through a car wash.

FIGS. 3a and 3b are plan views of the preferred embodiment of the present invention.

FIG. 4a-4c is a series of diagrams of the straight pivot arm of the prior art illustrating the movement and the associated forces of the straight pivot arm.

FIG. 5a-5c is a series of diagrams of the bent pivot arm of the preferred embodiment of the present invention illustrating the movement and the associated forces of the bent pivot arm.

### DETAILED DISCUSSION OF THE PREFERRED EMBODIMENTS

Referring to the figures, like elements retain their indicators throughout the several views.

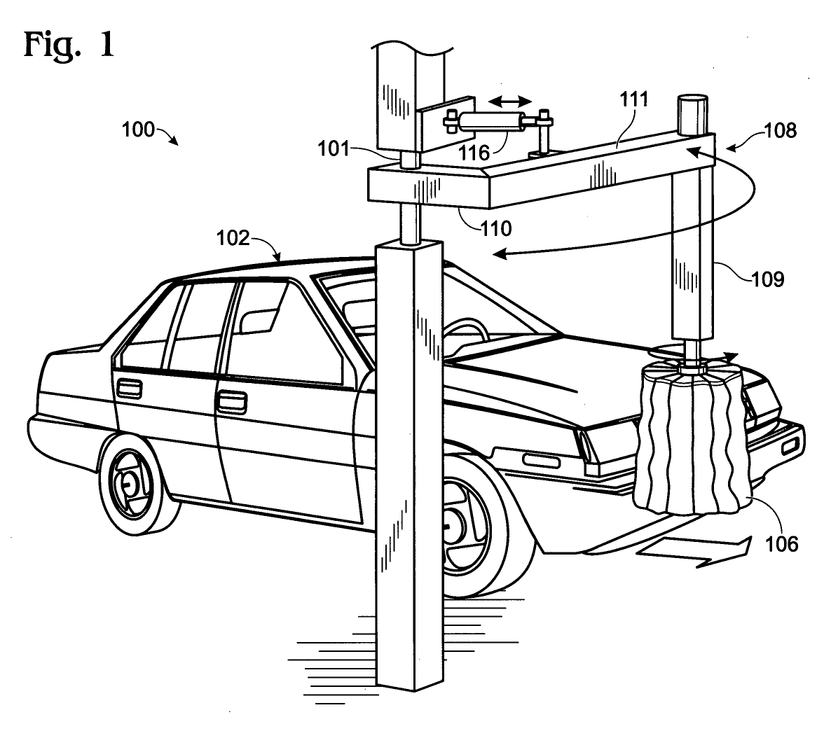

FIG. 1 is a perspective view of Car Wash 100 depicting the placement of Bent Arm 108 of the preferred embodiment of the present invention. Car 102 is shown driving through Car Wash 100. As Car 102 enters Car Wash 100, water is spraying onto Car 102. The vertical surfaces are cleaned with a combination of vertical, rotating brushes. FIG. 1 shows one of these vertical brushes. Vertical Spinning Brush 106, in the preferred embodiment, is attached to Bent Arm 108. In the preferred embodiment, Bent Arm 108 is comprised of Vertical Arm Section 109 which is attached to Second Arm Section 111 at a right angle. Second Arm Section 111 is attached to First Arm Section 110 at a right angle in the horizontal plane. Vertical Spinning Brush 106 is attached to the end opposite Second Arm Section 111. First Arm Section 110 is pivotally attached at Pivot Point 101 to the overhead frame (not shown) of Car Wash 100. Second Arm Section 111 reaches across Car 102 and is of a length that allows Vertical Spinning Brush 106 to make initial contact with Car 102 proximate the center front of Car 102. In the preferred embodiment, First Arm Section 110 is shorter than Second Arm Section 111 and is fixedly attached to Second Arm Section 111 at an approximate 90 degree angle creating an L-shape lying flat with the horizon. It has been contemplated that First Arm Section 110 be equal to or longer than Second Arm Section 111, however this will increase the overall size of Bent Arm 108 requiring more space within Car Wash 100.

Moving through Car Wash 100, Car 102 contacts Vertical Spinning Brush 106 forcing Bent Arm 108 away from Car 102 by pivoting at Bent Arm Pivot Point 101. As a result, Vertical Spinning Brush 106 moves across the front of Car 102 while spinning and thereby cleaning the front portion of Car 102. Bent Arm 108 is biased toward the initial, centered position by Tensioning Device 116 that applies a spring force to Second Arm Section 111 pulling it and Vertical Spinning Brush 106 toward Car 102. As Vertical Spinning Brush 106 clears the front of Car 102, it continues to spin and the force of Tensioning Device 116 on Bent Arm 108 maintains contact between Vertical Spinning Brush 106 and Car 102, thereby cleaning the side of Car 102 as it passes by. When Car 102 has traveled past the reach of Vertical Spinning Brush 106 attached to Bent Arm 108, Bent Arm 108 is returned to the initial position by Tensioning Device 116.

A similar arm and brush combination (not shown) are positioned on the opposite side of Car 102 to clean the vertical surfaces on the other half of Car 102.

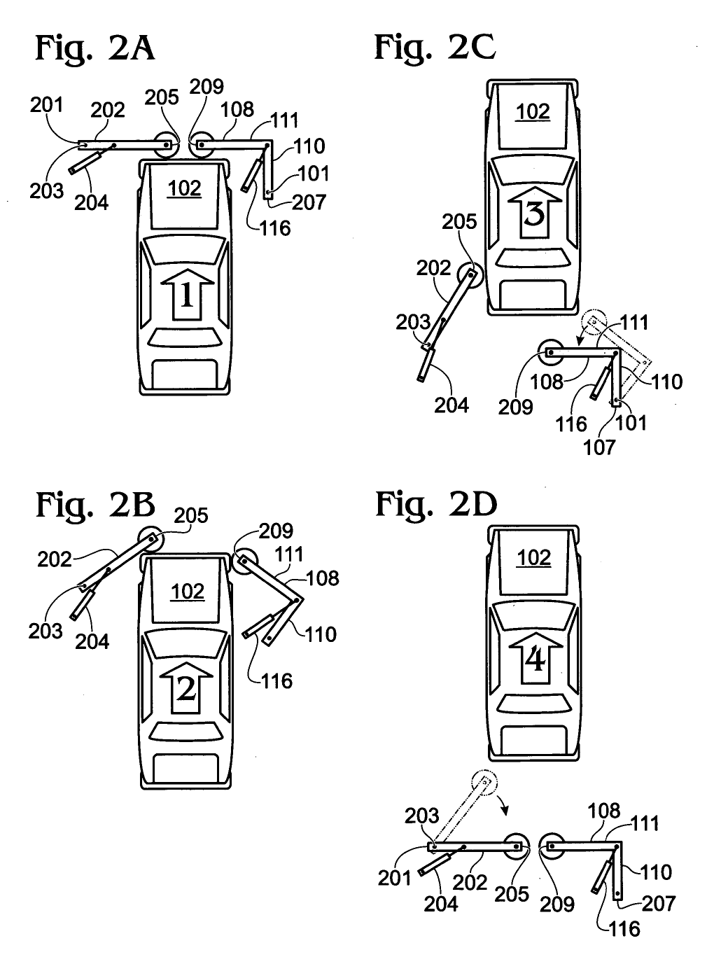

FIG. 2a-2d is a series of sequential plan views illustrating the comparative movement of Straight Arm 202 of the prior art and Bent Arm 108 of the preferred embodiment of the present invention around a car.

FIG. 2a depicts Car 102 at initial entry into a car wash. Straight Arm 202 is in the initial position—perpendicular to the movement of Car 102. It is held in position by Straight Tensioning Device 204 which biases Straight Arm 202 toward oncoming Car 102. Straight Arm 202 pivots away from Car 102 as Car 102 progresses through the car wash forcing Straight Arm 202 away from Car 102 as it pivots at Straight Arm Pivot Point 203 proximal to First End of Straight Pivot Arm 201.

Comparatively, Bent Arm 108 is shown in the initial position with First Bent Arm Section 110 parallel to the movement of Car 102 and fixedly attached at a 90 degree angle to Second Bent Arm Section 111 which is approximately perpendicular to the movement of Car 102. Bent Arm 108 is held in its initial position by Bent Arm Tensioning Device 206 which biases Second End of Bent Arm 209 toward Car 102. As Car 102 progresses into the car wash, Bent Arm 108 pivots at Bent Arm Pivot Point 101 away from Car 102 as it moves forward through the car wash.

FIG. 2b shows Car 102 after entry into the car wash. Straight Arm 202 is shown just after clearing the front section of Car 102 and beginning progression down the side of Car 102. Bent Arm 108 is also shown after passing across the front of Car 102. However, Bent Arm 108 has progressed farther down the side of Car 102 than Straight Arm 202 after the same distance of travel of Car 102.

FIG. 2c shows Car 102 just after Bent Arm 108 has cleared the back of Car 102 and has returned to its initial position while Straight Arm 202 is still in contact with the side of Car 102. At this point, with respect to Bent Arm 108, the car wash has completed its cycle. However, with Straight Arm 202, approximately a third of Car 102 is yet to be washed.

FIG. 2d shows Straight Arm 202 finally clearing the back of Car 102 and returning to its initial position. The FIG. 2a through 2d series demonstrates the ability of Bent Arm 108 to complete the washing of the front and sides of Car 102 significantly sooner than Straight Arm 202 allowing the length of the car wash to be shorter. A shorter car wash decreases the expense of the car wash by decreasing the conveyor system length, real estate requirements, and heating needs.

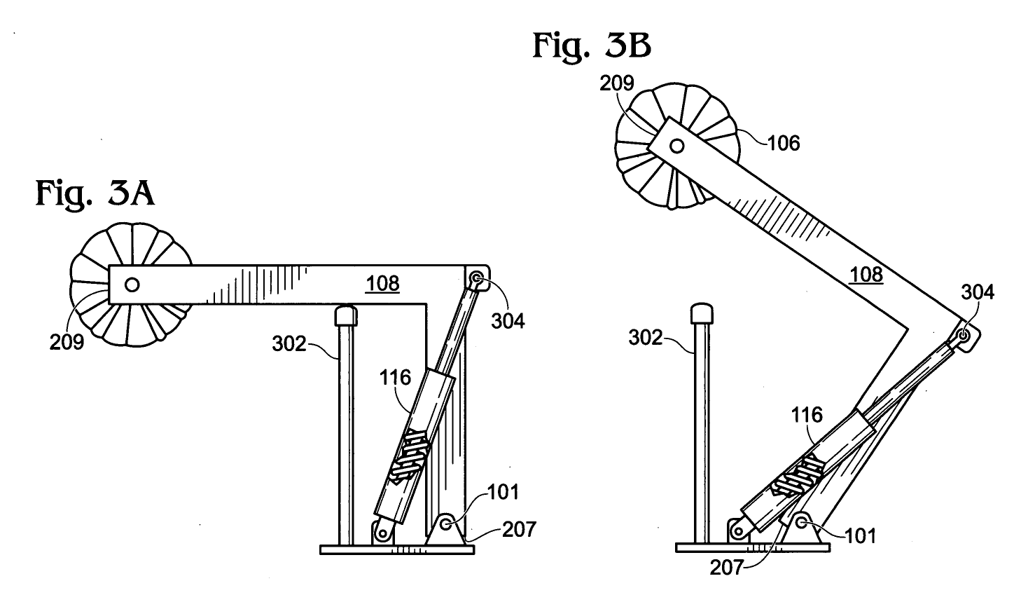

FIGS. 3a and 3b are plan views of the preferred embodiment of the present invention. FIG. 3a depicts Bent Arm 108 in a retracted or initial position being held in place by Bent Arm Tensioning Device 116 and resting against Arm Stop 302. Although Tensioning Device 116 is shown attached to Bent Arm 108 at Tension Attachment Point 304, it has been contemplated that the point of attachment can be at other points proximal the bend of Bent Arm 108.

FIG. 3b depicts Bent Arm 108 in a slightly extended position pushing Bent Arm 108 away from Arm Stop 302. The force of Car 102 (not shown) has overcome the tension applied by Bent Arm Tensioning Device 116 to Bent Arm 108 thereby pivoting Bent Arm 108 at Pivot Point 101 allowing Vertical Spinning Brush 106 to move across the front and down the side of Car 102 as it proceeds through Car Wash 100.

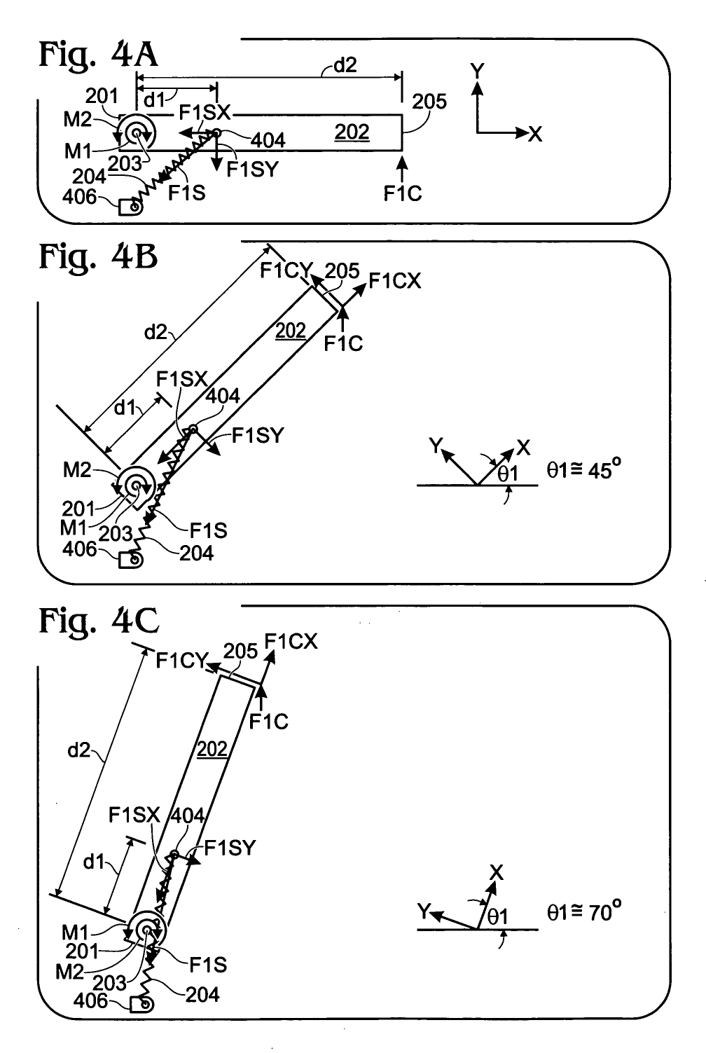

FIG. 4a-4c is a series of diagrams of Straight Arm 202 of the prior art illustrating the movement and the resulting forces of Straight Arm 202. The rotational force applied by Straight Arm Tensioning Device 204 at Arm Pivot Point 203 is called a “moment.” A moment is the tendency to cause rotation about a point or axis and is the product of the distance between the point of contact of the force and the point of rotation and the strength of the applied force perpendicular to that distance. This distance is also called a “moment arm.” In this case, the moment arm, d1, is the distance between Straight Arm Pivot Point 203 and Straight Arm Tension First Attach Point 404. The spring force, F1S, has an x-component, F1SX, and a y-component, F1SY. F1SY is the perpendicular force that creates the moment, M1. Since d1 is a constant distance and F1SY will varying with the rotation of Straight Arm 202 and the resulting stretching of Straight Arm Tensioning Device 204, the strength of M1 will vary with the strength of F1SY.

M1 is shown in FIG. 4a with a rotation in the clockwise direction denoted by the circular arrow around Straight Arm Pivot Point 203. Straight Arm Tensioning Device 204 is attached to Straight Arm 202 at Straight Arm Tension First Attach Point 404 and to the car wash structure (not shown) at Straight Arm Tension Second Attach Point 406. M1 is calculated by the equation:
M1=d1×F1SY

There is a second, opposite rotational force, or moment, at Arm Pivot Point 203 due to the force of Car 102 pressing against Straight Arm 202 as it proceeds through Car Wash 100. This second moment, M2, has a moment arm, d2, that spans from Straight Arm Pivot Point 203 to Second Straight Arm End 205 which is the point of contact from Car 102 as it moves into and through Car Wash 100. The force applied by Car 102, F1C, also has an x-component, F1CX, and a y-component, F1CY. F1CY is the force perpendicular to moment arm, d2. M2 is shown in FIG. 4a with a rotation in the counter-clockwise direction denoted by the outer circular arrow around Straight Arm Pivot Point 203.

In order for Straight Arm 202 to rotate, rotational force M2 must be greater than opposing rotational force M1. M2 is calculated by the equation:
M2=d2×F1CY

In FIG. 4a, Car 102 has just reached Straight Arm 202 and has yet to apply any force to Straight Arm 202. The rotational force M1 maintains Straight Arm 202 in the initial position. Typically, Straight Arm 202 is biased toward a bumper or a stop (not shown). In this initial position, F1SX is similar in strength to F1SY.

In the initial position there is no rotation of Straight Arm 202 as Car 102 has not applied any pressure to Straight Arm 202. Therefore, F1C and its y-component, F1CY, equal zero.

In FIG. 4b, due to the application of force F1C by Car 102 pushing against Straight Arm 202, Straight Arm 202 is shown rotated at Straight Arm Pivot Point 203 approximately 45 degrees from the initial position causing Straight Arm Tensioning Device 204 to stretch and slightly rotate counter-clockwise. Although initially, F1SX (x-component of the spring force) and F1SY (y-component of the spring force) are very similar, this counter-clockwise rotation has caused the distribution of force at Straight Arm Tension First Attach Point 404 to have an increased x-component, F1SX. Since F1S is a constant spring force, when F1SX increases, F1SY naturally decreases.

Similarly, with rotational force M2, d2 is a constant. F1C is a constant force as Car 102 is traveling through Car Wash 100 on a constant speed conveyor system. As Straight Arm 202 rotates, F1C begins to have an x-component, F1CX, thereby decreasing F1CY. A decrease in F1CY decreases rotational force M2.

FIG. 4c illustrates the point of maximum deflection of Straight Arm 202. This is the point at which Vertical Spinning Brush 106 (not shown) begins traveling down the side of Car 102 as Car 102 passes through Car Wash 100. Straight Arm 202 sweeps through approximately 70 degrees of rotation from Car 102's entry into the car wash until Car 102 passes by Straight Pivot Arm 202. M1 is the spring force that biases Straight Arm 202 toward Car 102 applying the pressure from Vertical Spinning Brush 106 in an effort to clean Car 102. As can be seen in FIG. 4c, F1SY is approaching zero and F1S is almost completely an x-component force diminishing M1 to almost zero as M1 equals d1 multiplied by F1SY. As a result, Vertical Spinning Brush 106 is applying minimal pressure to the side of Car 102, therefore providing little or no pressure for cleaning.

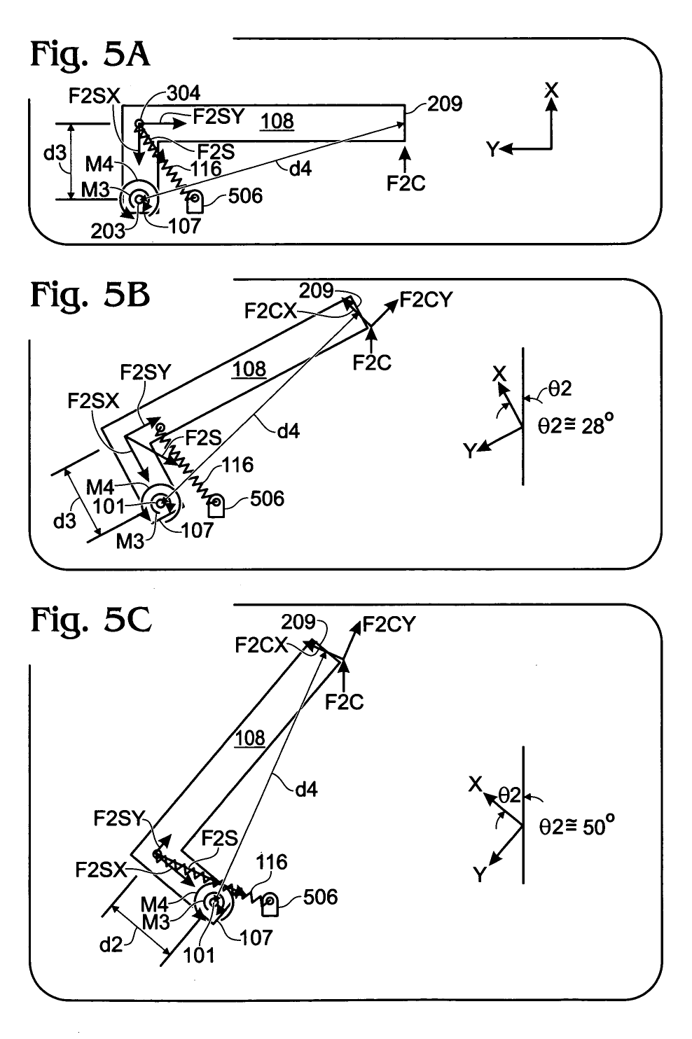

FIG. 5a-5c is a series of diagrams of Bent Arm 108 of the preferred embodiment of the present invention illustrating the movement and the resulting forces of Bent Arm 108. Tensioning Device 116 is attached to Bent Arm 108 at Tension Attach Point 304. Tensioning Device 116 is anchored to Car Wash 100 (not shown) at a point on the interior frame (not shown) of Car Wash 100. As previously discussed in FIG. 4a-4c, there are two rotational forces, or moments applied to Bent Arm 108.

As depicted in FIG. 5a, the first rotational force, or moment M3, has a moment arm, d3, which spans from Tension Attach Point 304 to Pivot Point 101. Tensioning Device 116 applies the force F2S to Bent Arm 108. It is the y-component, F2SY that creates the rotational force, M3. The equation for M3 is:
M3=d3×F2SY

The second rotation force, or moment M4, has a moment arm, d4, which spans from Bent Arm Second End 209 to Pivot Point 101. Car 102 applies the force F2C to Bent Arm 108 at Bent Arm Second End 209. In order for Bent Arm 108 to rotate, rotational force M4 must be greater than opposing rotational force M3. M4 is calculated by the equation:
M4=d4×F2CX

In the initial position there is no rotation of Bent Arm 108. Tensioning Device 116 applies force, F2S to Bent Arm 108 at Tension Attachment Point 304 biasing Bent Arm 108 against a bumper or stop (not shown) until pressure is applied by Car 102.

In FIG. 5b, due to the application of force F2C by Car 102 pushing against Bent Arm 108, Bent Arm 108 is shown rotated at Pivot Point 101 approximately 28 degrees from the initial position causing Tensioning Device 116 to stretch and slightly rotate counter-clockwise. Although initially, F1SX and F1SY are very similar, this counter-clockwise rotation has caused the distribution of force at Tension Attach Point 304 to have an increased x-component, F1SY. Since F1S is a constant spring force, when F1SY increases, F1SX decreases.

Comparing forces applied by Car 102 to Straight Arm 202 and Bent Arm 108, it can be seen from FIG. 4b and FIG. 5b that even though both arms have moved away or progressed around Car 102 the same distance, Straight Arm 202 rotates approximately 45 degrees from neutral while Bent Arm 108 only has to rotate approximately 28 degrees from its initial or neutral position. In both scenarios, the moment arms are constant and, as previously discussed, the perpendicular applied forces decrease as the arms rotate.

FIG. 5c illustrates the point of maximum deflection of Bent Arm 108 which requires only an approximate rotation of 50 degrees. This is the point at which Vertical Spinning Brush 106 (not shown) begins traveling down the side of Car 102 as Car 102 passes through Car Wash 100. In comparison, Straight Arm 202 sweeps through approximately 70 degrees of rotation from Car 102's entry into the car wash until Car 102 passes by Straight Pivot Arm 202.

The lesser rotation of Bent Arm 108 (˜50 degrees) in comparison to Straight Arm 202 (˜70 degrees), allows a more constant force being applied to Car 102. Throughout the process, Bent Arm 108 maintains a significant perpendicular force component, F2CX, keeping Vertical Spinning Brush 106 (not shown) biased toward Car 102 during the side cleaning portion of the process. As previously discussed and illustrated in FIG. 4c, during the side cleaning portion of the process, the perpendicular force component, F1CY, has diminished to almost nothing thereby applying minimal pressure to hold Straight Arm 202 against Car 102. This applied pressure is critical to the quality of the dirt removal from the sides of Car 102.

In summary, comparing FIG. 4a-4c to FIG. 5a-5, Straight Arm 202 sweeps through a greater angle than Bent Arm 108 in order for Car 102 to pass through the car wash. As the angle of deflection increases, the moment on the pivot arm, whether straight or bent, decreases as the perpendicular component of the tensioning force decreases. The perpendicular component of the tensioning force is what applies pressure to the sides of Car 102. With Straight Arm 202, in order to have enough tensioning force left after the arm has rotated to the side of Car 102 to do a quality cleaning on the sides of Car 102, the initial force is so great that fixtures on the front of Car 102, such as license plates and grill guards, are ripped off by the rotating brushes pressing too forcefully against Car 102. To assist Straight Arm 202 to move across the front of Car 102, it is necessary to spin Vertical Spinning Brush 106 in the direction of Car 102's movement. However, this rotation tends to push Vertical Spinning Brush 106 away from Car 102 again leaving minimal cleaning pressure along the sides of Car 102.

Additionally, the movement of Bent Arm 108 in comparison to Straight Arm 202 allows the length of Car Wash 100 to be shorter. As demonstrated in FIG. 2a-2d, Bent Arm 108 clears the end of Car 102 measurably quicker than Straight Pivot Arm 202. There are economic benefits to a smaller car wash such as less heating requirements, smaller real estate requirements, and less materials costs to build.

Wherein the terms and expressions which have been employed in the foregoing specification are used therein as terms of description and not of limitation, there is no intention, in the use of such terms and expressions, of excluding equivalents of the features shown and described or portions thereof, it being recognized that the scope of the invention is defined and limited only by the claims which follow.

I claim:

1. An apparatus for treating the exterior surfaces of a vehicle, comprising:
a vertical support member having a first end fixedly attached to a floor and an opposing second end;
a horizontal support arm have a first arm end pivotally attached to said opposing second end of said vertical support member and a second arm end, said horizontal support arm having an angular bend proximate said first arm end, said horizontal support arm is essentially parallel to the ground and approximately eight feet above the ground;
a brush rotatably attached to said second arm end and perpendicular to said horizontal support arm, said brush having at least one vertical washing fabric attached vertically to said brush, said brush rotates horizontally.

2. An apparatus according to claim 1, wherein said angular bend is approximately forty-five degrees.

3. An apparatus according to claim 1, wherein said angular bend is approximately ninety degrees.

4. An apparatus according to claim 1, wherein said brush rotates in a clockwise direction.

5. An apparatus according to claim 1, wherein said brush rotates in a counter-clockwise direction.

6. An apparatus according to claim 1, wherein said angular bend is proximate said second end of said horizontal support arm.

7. An apparatus according to claim 1, wherein said angular bend is approximately an equal distance between said first end and said second end of said horizontal support arm.

8. An apparatus according to claim 1, wherein said vertical washing fabric is felt.

9. An apparatus according to claim 1, wherein said washing fabric is Scotchbrite®.

10. An apparatus according to claim 1, wherein said washing fabric is cotton.

11. An apparatus for treating the exterior vertical surfaces of a vehicle, comprising:
a vertical support member having a first end fixedly attached to a floor and an opposing second end;
a horizontal support arm have a first arm end pivotally attached to said opposing second end of said vertical support member and a second arm end, said horizontal support arm having an approximate ninety degree bend proximate said first arm end, said horizontal support arm is essentially parallel to the ground and approximately eight feet above the ground;
a spinning brush rotatably attached to said second arm end and perpendicular to said horizontal support arm, said spinning brush having at least one vertical washing fabric attached vertically to said spinning brush, said spinning brush rotates horizontally.

12. An apparatus according to claim 11, wherein said spinning brush rotates in a clockwise direction.

13. An apparatus according to claim 11, wherein said spinning brush rotates in a counter-clockwise direction.

14. An apparatus according to claim 11, wherein said approximate ninety degree bend is proximate said second end of said horizontal support arm.

15. An apparatus according to claim 11, wherein said approximate ninety degree bend is approximately an equal distance between said first end and said second end of said horizontal support arm.

16. An apparatus according to claim 11, wherein said vertical washing fabric is felt.

17. An apparatus according to claim 11, wherein said washing fabric is Scotchbrite®.

18. An apparatus according to claim 11, wherein said washing fabric is cotton.
